(19) United States
(12) Patent Application Publication
(10) Pub. No.: US 2026/0166495 A1
(43) Pub. Date: Jun. 18, 2026

(54) FILTRATION MEMBRANE, FILTRATION DEVICE AND MANUFACTURING METHOD OF FILTRATION MEMBRANE

(71) Applicant: Industrial Technology Research Institute, Hsinchu (TW)

(72) Inventors: Chung-Wei FU, Zhudong Township (TW); Chun-Nan KUO, Taichung City (TW); Ju-Chen HSU, Hsinchu City (TW); Yu-Lun LAI, Tainan City (TW); Shaw-I YAN, Zhudong Township (TW)

(73) Assignee: Industrial Technology Research Institute, Hsinchu (TW)

(21) Appl. No.: 19/307,375

(22) Filed: Aug. 22, 2025

(30) Foreign Application Priority Data
Dec. 17, 2024 (TW) 113149186

(51) Int. Cl. B01D 67/00; B01D 69/02; B01D 71/02; B01D 71/70

(52) U.S. Cl. CPC B01D 67/0088; B01D 67/0083; B01D 69/02; B01D 71/0223; B01D 71/701; B01D 2323/081; B01D 2323/36; B01D 2325/02834; B01D 2325/04; B01D 2325/06

(57) ABSTRACT

A filtration membrane, a filtration device and a manufacturing method for the filtration membrane are provided. The filter membrane of the present disclosure includes a mesh structure. The mesh structure includes stainless steel. The pore size of the mesh structure is 10 μm or less. The surface of the mesh structure has a microstructure. A modification layer is disposed on the mesh structure. The modification layer contains an alkoxysilane compound, a halosilane compound, or a polyalkylsiloxane compound disposed on the mesh structure. The modification layer is coated on the mesh structure in a manner that conforms to the morphology of the microstructure.

### CROSS REFERENCE TO RELATED APPLICATIONS

This application claims priority of Taiwan Patent Application No. 113149186, filed on Dec. 17, 2024, the entirety of which is incorporated by reference herein.

### TECHNICAL FIELD

The present disclosure relates to a filtration membrane, a filtration device, and a method for manufacturing the filtration membrane. More particularly, it relates to a filtration membrane, a filtration device, and a method for manufacturing the filtration membrane for use in filtering emulsions containing microparticles.

### BACKGROUND

Cutting, grinding, and polishing steps of the semiconductor manufacturing process are often required to process silicon carbide (SiC) substrates into the desired dimensions. The waste materials generated from these steps typically contain a large amount of high-value silicon carbide and diamond powder. However, most of such waste materials are currently disposed of in landfills, after undergoing appropriate treatment. With the increasing awareness of the need for renewable energy and environmental protection, improving the recovery rate of these waste materials has become an important issue.

Currently, the method for recovering the aforementioned silicon carbide waste typically involves initially t dispersing the waste to form an emulsion having an oil phase and a water phase. Then, a separation agent or other means is used so that silicon carbide is retained in the water phase while diamond powder is retained in the oil phase. Subsequently, the emulsion is agitated and mixed to promote phase separation, followed by demulsification via ultrasonic waves or other techniques. Finally, microparticles contained in the emulsion are recovered using filtration membranes.

However, in the aforementioned process for demulsifying the emulsion, effective demulsification of emulsions containing microparticles often requires pressurization, heating, or the use of chemical such agents. These additional steps complicate the overall manufacturing process and may lead to environmental pollution due to the involvement of chemical agents. Moreover, inadequate demulsification hampers the proper recovery of separation agents. Furthermore, conventional filtration membranes are typically composed of organic polymeric materials, such as melamine sponge, nylon, cellulose, and the like. However, these materials generally have low mechanical strength, making them difficult to process (e.g., by etching) and less durable. In addition, organic polymer membranes typically have a three-dimensional porous structure with relatively large pore sizes. During filtration, particle separation relies on the formation of a filter cake; however, once the pores become clogged, the filtration process can no longer proceed. While membranes with smaller pore sizes may enhance filtration efficiency, they also accelerate filter cake formation, resulting in a decline in membrane flux. Therefore, conventional filtration membranes are insufficient for efficient microparticle filtration. There is a need for a filtration membrane that simplifies the filtration process, achieves high recovery efficiency for microparticles, and provides enhanced mechanical durability.

### SUMMARY

An embodiment of the present disclosure provides a filtration membrane, a filtration device, and a method for manufacturing the filtration membrane, which are capable of demulsifying at room temperature, achieving high recovery efficiency of microparticles, and exhibiting excellent mechanical durability.

A filtration membrane comprises a mesh structure and a modification layer. The mesh structure comprises stainless steel. The mesh structure has a pore size of 10 μm or less. A microstructure is formed on the surface of the mesh structure. The modification layer comprising an alkoxysilane compound, a halosilane compound, or a polyalkylsiloxane compound, is disposed on the mesh structure. The modification layer is coated on the mesh structure in a manner that conforms to the morphology of the microstructure.

A filtration device comprises the filtration membrane described above.

A method for manufacturing a filtration membrane comprises: (a) etching a mesh structure comprising stainless steel to form a microstructure on its surface, wherein the mesh structure has a pore size of 10 μm or less; (b) dissolving a modifying agent comprising an alkoxysilane compound, a halosilane compound, or a polyalkylsiloxane compound in a first solvent to obtain a modification solution; and (c) coating the modification solution on the mesh structure that has been etched, to form a modification layer, wherein the modification layer is coated on the mesh structure in a manner that conforms to the morphology of the microstructure.

The filtration membrane of the present disclosure exhibits excellent mechanical durability due to the use of a mesh structure in which a stainless steel mesh material with a relatively small pore size serves as the substrate. Compared with organic polymer membranes, the stainless steel substrate is compatible with etching processes. Furthermore, compared with organic polymer membranes that have large pore diameters, the filtration membrane of the present disclosure achieves improved microparticle recovery. In addition, in the filtration membrane of the present disclosure, a modification layer containing specific materials is formed on the etched mesh structure. This configuration, comprising a rigid and durable substrate in combination with a thin modification layer having a thickness within a defined range, imparts excellent hydrophobicity to the filtration membrane. As a result, the filtration membrane of the present disclosure is capable of performing demulsifying at room temperature, while also providing high microparticle recovery efficiency and superior durability.

A detailed description is given in the following embodiments with reference to the accompanying drawings, in order to make the disclosure more comprehensible.

### BRIEF DESCRIPTION OF THE DRAWINGS

The present invention can be more fully understood by reading the subsequent detailed description and examples with references made to the accompanying drawings, wherein:

FIG. 1 is a partial cross-sectional schematic diagram of a filtration membrane according to the present disclosure.

FIG. 2 is a flowchart illustrating a method for manufacturing a filtration membrane according to the present disclosure.

FIGS. 3A-3F show scanning electron microscope (SEM) images of filtration membranes subjected to different etching times, wherein FIG. 3A and FIG. 3B show images of filtration membranes respectively etched for 30 seconds; FIG. 3C and FIG. 3D show images of filtration membranes respectively etched for 1 minute; and FIG. 3E and FIG. 3F show images of filtration membranes respectively etched for 3 minutes.

FIGS. 4A and 4B show SEM images of modification layers formed using different coating processes according to the present disclosure.

FIGS. 5A-5C show SEM images and graphs of filtration membranes prepared using different concentrations of modifying agents according to the present disclosure, wherein FIG. 5A is an SEM image of a filtration membrane prepared by a 60 mM modifying agent; FIG. 5B is a scanning electron microscope-energy dispersive X-ray spectroscopy (SEM-EDS) graph of a filtration membrane prepared by a 60 mM modifying agent; and FIG. 5C is an SEM image of a filtration membrane prepared by a 10 mM modifying agent.

FIG. 6 is a bar chart illustrating the water contact angles and oil contact angles of filtration membranes according to various examples and comparative examples.

FIGS. 7A and 7B show SEM images of a filtration membrane prepared by the method of the present disclosure.

FIGS. 8A-8C show microscopic images of an emulsion before and after filtration using the filtration membrane of the present disclosure, wherein FIG. 8A shows the emulsion before filtration; FIG. 8B shows the filtrate after filtration; and FIG. 8C shows the filter cake after filtration.

### DETAILED DESCRIPTION

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

It should be noted that, unless explicitly stated otherwise, the singular forms “a,” “an,” and “the” as used in the present specification and claims are intended to include the plural forms as well. Accordingly, unless otherwise indicated by the context, singular terms may also refer to plural entities, and vice versa.

The following provides a detailed description of the filtration membrane, the filtration device, and the method for manufacturing the filtration membrane according to the present disclosure.

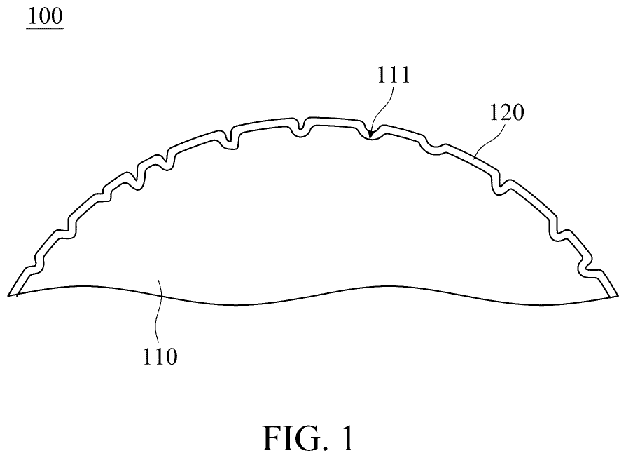

In one embodiment of the present disclosure, as illustrated in FIG. 1, the present disclosure provides a filtration membrane 100, which comprises a mesh structure 110 and a modification layer 120. The mesh structure 110 comprises stainless steel and has a pore size of 10 μm or less and the surface of the mesh structure 110 has a microstructure 111. The modification layer 120 comprises an alkoxysilane compound, a halosilane compound, or a polyalkylsiloxane compound, and is disposed on the mesh structure 110. The modification layer 120 is coated on the mesh structure 110 in a manner that conforms to the morphology of the microstructure 111, such that the modification layer 120 adheres along a surface relief without filling or flattening the microstructure 111. Therefore, the original structure of the microstructure 111 is retained, and the filtration or permeability performance is not adversely affected. Furthermore, in some embodiments, the modification layer 120 may at least partially does not cover the microstructure of the mesh structure. By using the filtration membrane 100 of the present disclosure, demulsification can be carried out at room temperature, with high microparticle recovery efficiency, effective oil-water separation, and excellent durability.

In one embodiment of the present disclosure, the mesh structure 110 may be made of stainless steel and used as a mesh substrate. The pore size of the stainless steel mesh may be 10 μm or less, for example, about 8 μm, 7 μm, 6 μm, 5 μm, 4 μm, 3 μm, or 1 μm, etc.; or a range such as 1 μm to 9 μm, 2 μm to 7 μm, or 3 μm to 5 μm. By using stainless steel meshes having such pore sizes, microparticles in the emulsion can be effectively filtered. Furthermore, using stainless steel as the material enables effective processing such as etching and the like to form the desired recessed microstructures 111 on its surface. Specifically, the surface of the mesh structure 110 comprises a microstructure 111, which may include, for example, a plurality of depressions formed by etching or other methods; however, the present disclosure is not limited thereto, and any method capable of effectively forming microstructures 111 on the stainless steel mesh may be employed. In some embodiments, the diameters of the depressions may range from 0.2 to 3 μm and the depths of the depressions may range from 10 to 300 nm. For example, the diameter may be about 0.3 μm, 0.6 μm, 1.0 μm, 1.3 μm, 1.6 μm, 2.0 μm, 2.3 μm, or 2.6 μm, etc., and the depth may be about 25 nm, 50 nm, 75 nm, 100 nm, 125 nm, 150 nm, 170 nm, 200 nm, 225 nm, 250 nm, or 275 nm, etc. Forming such microstructures 111 on the mesh structure 110 can effectively increase the contact angle of water droplets, thereby enhancing hydrophobic performance. The details of water contact angle measurements method are described in the following examples.

In one embodiment of the present disclosure, the modification layer 120 comprises an alkoxysilane compound, a halosilane compound, or a polyalkylsiloxane compound and is disposed onto the mesh structure 110. By coating a modifying agent comprising alkoxysilane compound, halosilane compound, or polyalkylsiloxane compound on the etched mesh structure 110, a modification layer 120 is formed on the mesh structure 110 to enhance the oleophilic and hydrophobic properties. The modification layer 120 of the present disclosure may be the reaction product of a modifying agent comprising an alkoxysilane compound, a halosilane compound, or a polyalkylsiloxane compound.

In one embodiment of the present disclosure, the alkoxysilane compounds and halosilane compounds in the modifying agent may also be referred to as “specific silane compounds.” An alkoxysilane compound may be silane compounds having an alkoxy group, and a halosilane compound may be silane compounds having a halogen group. In alkoxysilane compounds or halosilane compounds, in addition to the alkoxy or halogen groups, these compounds may further include one or a plurality of other functional groups. Moreover, the compound may include one or a plurality of alkoxy or halogen groups. When these compounds include a plurality of the alkoxy or halogen groups, and the alkoxy or halogen groups can be identical or different.

In one embodiment of the present disclosure, the specific silane compound may be an alkoxysilane compound. Examples of the alkoxy group may include methoxy, ethoxy, n-propoxy, or isopropoxy. Furthermore, the alkoxysilane compound may include at least one alkyl functional group having 8 to 20 carbon atoms. For alkyl functional group may include 10 to 20 carbon atoms, 12 to 18 carbon atoms, or 15 to 18 carbon atoms, etc. Examples of alkyl functional group may include octyl, nonyl, decyl, undecyl, dodecyl, tridecyl, tetradecyl, pentadecyl, hexadecyl, heptadecyl, octadecyl, nonadecyl, eicosyl, and the like, in either linear or branched form.

Specifically, examples of alkoxysilane compounds may include, for example octyltrimethoxysilane, nonyltrimethoxysilane, decyltrimethoxysilane, undecyltrimethoxysilane, dodecyltrimethoxysilane, tridecyltrimethoxysilane, tetradecyltrimethoxysilane, pentadecyltrimethoxysilane, hexadecyltrimethoxysilane, heptadecyltrimethoxysilane, octadecyltrimethoxysilane (ODTMS), octadecyltriethoxysilane, nonadecyltrimethoxysilane, eicosyltrimethoxysilane and the like.

In one embodiment of the present disclosure, the specific silane compound may be a halosilane compound. Example of halogen group may include fluorine, chlorine, or bromine. In addition, the halosilane compound may include at least one alkyl functional group having 8 to 20 carbon atoms. For alkyl functional group may include 10 to 18 carbon atoms, 12 to 18 carbon atoms, or 15 to 18 carbon atoms. Examples of alkyl functional group may include octyl, nonyl, decyl, undecyl, dodecyl, tridecyl, tetradecyl, pentadecyl, hexadecyl, heptadecyl, octadecyl, nonadecyl, eicosyl and the like, which may be either in linear or branched form.

Specifically, examples of halosilane compounds may include octyltrifluorosilane, octyltrichlorosilane, nonyltrifluorosilane, nonyltrichlorosilane, decyltrifluorosilane, decyltrichlorosilane, undecyltrifluorosilane, undecyltrichlorosilane, dodecyltrifluorosilane, dodecyltrichlorosilane, tridecyltrifluorosilane, tridecyltrichlorosilane, pentadecyltrifluorosilane, pentadecyltrichlorosilane, hexadecyltrifluorosilane, hexadecyltrichlorosilane, heptadecyltrifluorosilane, heptadecyltrichlorosilane, octadecyltrifluorosilane, octadecyltrichlorosilane (ODTCS), nonadecyltrifluorosilane, nonadecyltrichlorosilane, eicosyltrifluorosilane, eicosyltrichlorosilane, and the like.

In another embodiment of the present disclosure, the polyalkylsiloxane compound in the modifying agent may include alkyl groups with 1 to 8 carbon atoms bonded to the silicon. Examples of alkyl group may include methyl, ethyl, propyl, butyl, pentyl, hexyl groups, and the like, which may be in linear or branched form. Specifically, the polyalkylsiloxane compound may, for example, be polydimethylsiloxane (PDMS).

The modifying agent may be in the form of a modification solution in which the modifying agent is dissolved in a solvent. For example, when the modifying agent is prepared as a modification solution, the inclusion of a solvent facilitates the coating of the modifying agent. The solvent functions to dissolve the components contained in the modifying agent and may also serve as a dispersion medium. Examples of solvents include ketones such as methyl ethyl ketone, methyl isobutyl ketone, cyclohexanone, and the like; esters such as ethyl acetate, propyl acetate, butyl acetate, and the like; aliphatic hydrocarbons such as n-hexane, heptane, and the like; and ethers such as tetrahydrofuran, dioxane, diethyl ether, dibutyl ether, and the like. These solvents may be used individually or in combination of two or more.

In one embodiment of the present disclosure, the modification solution may be coated by methods such as solvent casting, spray coating, dip coating, and the like. For example, the modification solution may be applied on the mesh structure 110 in a manner that conforms to the morphology of the microstructure 111, such that the modification layer 120 adheres along a surface relief without filling or flattening the microstructure 111. In another embodiment of the present disclosure, the modification solution may be applied so as not to cover the microstructure 111 on the surface of the mesh structure 110. In some embodiments of the present disclosure, the modification solution is selectively applied to cover only a portion of the mesh structure 110 while leaving the microstructure 111 exposed, the thickness of the modification layer 120 formed on the mesh structure 110 after coating the modification solution and subsequent curing may range from 100 nm to 400 nm. The thickness of the modification layer 120 may be, for example, about 110 nm, 130 nm, 150 nm, 170 nm, 190 nm, 200 nm, 220 nm, 250 nm, 280 nm, 300 nm, 320 nm, 350 nm, 380 nm, 150 nm to 350 nm, 200 nm to 300 nm, and etc. If the modification layer 120 is too thick, the microstructures 111 may become relatively flattened, thereby reducing the oleophilic and hydrophobic effects. Conversely, if the modification layer 120 is too thin, insufficient coating may also reduce the oleophilic and hydrophobic effects.

In one embodiment of the present disclosure, the modification layer 120 may be conformed with, for example, at least 50%, 60%, 70%, 80%, 50% to 80%, or 60% to 70% of the surface of the microstructures 111. In one embodiment of the present disclosure, the water contact angle of the modification layer 120 may range from 120 degrees to 150 degrees, but is not limited thereto. For example, the water contact angle may be about 125, 130, 135, 140, 145 degrees, or 125 to 145 degrees. In the filtration membrane 100 of the present disclosure, maintaining a water contact angle of 120 degrees or higher allows the filtration membrane 100 to exhibit good hydrophobicity, thereby achieving excellent demulsification effect. If the water contact angle of the modification layer 120 is less than 120°, the resulting hydrophobicity may be insufficient for complete demulsification of the emulsion, potentially resulting in coexistence oil and water in the lower layer after the emulsion passes through the filtration membrane 100.

By using the filtration membrane 100 as described above, it is possible to achieve demulsification even at room temperature during filtration of emulsions containing microparticles (e.g., the emulsions generated in the waste treatment of silicon carbide substrates), while also achieving high microparticle recovery efficiency and excellent durability.

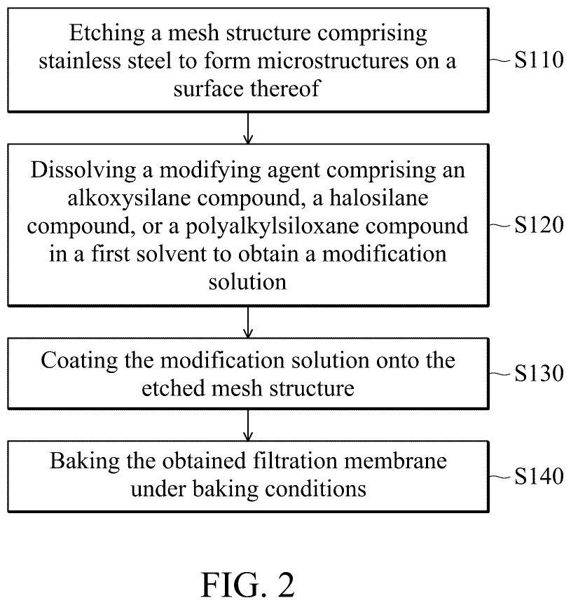

The filtration membrane of the present disclosure may be manufactured by the following method, as illustrated in FIG. 2. The method for manufacturing the filtration membrane of the present disclosure includes: etching a mesh structure comprising stainless steel to form microstructures on its surface (S110), wherein the pore size of the mesh structure is 10 μm or less; dissolving a modifying agent comprising an alkoxysilane compound, a halosilane compound, or a polyalkylsiloxane compound in a first solvent to obtain a modification solution (S120); coating the modification solution onto the etched mesh structure such that the modification layer is coated on the mesh structure in a manner that conforms to the morphology of the microstructure (S130); and baking the obtained filtration membrane under predetermined baking conditions (S140).

According to one embodiment of present disclosure, the step S110 involves etching a mesh structure comprising stainless steel. The selection of the stainless steel mesh as the base material of the mesh structure and the detail of the microstructures may be referred to the descriptions described above. Prior to the etching step, the stainless steel mesh may be pretreated, such as cleaning with deionized water, acetone and the like followed by drying, to remove organic or inorganic contaminants from the surface. In a specific embodiment of the present disclosure, the stainless steel mesh is subjected to wet etching using an etching solution, such as static wet etching, to form microstructures on its surface. The etching solution may be an acidic etching solution, for example but not limited to, a mixture of ferric chloride (FeCl₃) and hydrogen peroxide/hydrochloric acid, with concentration and ratios as needed. In step S110, the etching time may be a duration sufficient to form the microstructures, and may range from 15 seconds to 5 minutes. For example, the etching time may be 30 seconds, 1 minute, 1.5 minutes, 2 minutes, 2.5 minutes, 3 minutes, 3.5 minutes, 4 minutes, 4.5 minutes, etc. By adjusting the etching time within this range, the water contact angle of the modification layer in the resulting filtration mesh can fall within the desired range specified in the present disclosure.

According one embodiment of present disclosure, in step S120, the modifying agent comprising an alkoxysilane compound, a halosilane compound, or a polyalkylsiloxane compound is dissolved in a first solvent to obtain a modification solution. The details of alkoxysilane compound, halosilane compound, or polyalkylsiloxane compound may be referred to the description described above. By preparing the modifying agent as a modification solution, the modifying agent can be easily and uniformly coated on the mesh structure. In one embodiment of present disclosure, the first solvent may be an organic solvent capable of dissolving the silane compounds and being miscible with water. Examples of the first solvent include ketones such as methyl ethyl ketone, methyl isobutyl ketone, cyclohexanone, and the like; esters such as ethyl acetate, propyl acetate, butyl acetate, and the like; aliphatic hydrocarbons such as n-hexane, heptane, and the like; and ethers such as tetrahydrofuran, dioxane, diethyl ether, dibutyl ether, and the like. These solvents may be used alone or in combination with two or more solvents. In order to allow the modifying agent in the modification solution to be properly coated on the mesh structure, the concentration of the modifying agent in the modification solution may be, for example, 10 mM to 100 mM, but not limited to, such as about 20 mM, 40 mM, 60 mM, 80 mM, or within ranges such as 20 mM to 80 mM, 40 mM to 60 mM, etc. According to the present disclosure, the modifying agent can be coated on the mesh structure to form the modification layer having a desired thickness. The modification layer is applied to the mesh in such a way that it conforms to the original microstructure, thereby preventing the depressions from becoming clogged.

In step S130, the modification solution is coated onto the mesh structure to form a coating of the modification layer. During the coating step, the modification solution may be coated on the mesh structure by methods such as solvent casting, spray coating, dip coating, and the like to form the coating of modification layer. From the perspective of facilitating the formation of a coating with the desired thickness and morphology, a dip coating method may be employed during the coating step. In a specific embodiment of the present disclosure, the immersion time of the etched mesh structure in the modification solution may be appropriately adjusted based on the concentration of the modifying agent, for example, about 5 to 20 minutes, such as 5, 7, 10, 13, 15, or 18 minutes, etc.

According to a specific embodiment of the present disclosure, step S130 may further include immersing the mesh structure, after the modification solution has been coated thereon, into a second solvent. The second solvent may be a mixed solution of alcohol and water. The alcohol may include monohydric alcohols such as methanol, ethanol, propanol, 2-propanol, 1-butanol, and the like, or dihydric alcohols such as ethylene glycol, propylene glycol, butylene glycol, and the like. One or more types of alcohol may be used. The alcohol content may be, for example, 10 to 50 mass % or 20 to 40 mass %. Moreover, the immersion time may be appropriately adjusted according to alcohol concentration, and for example, not limited to, within about 60 seconds, such as, but not limited to, 50, 40, 30, 20, 10 seconds, etc. The above-described process enhances the uniformity of the formed modification layer and effectively prevents the clogging of the depressions on the mesh structure.

In step S140, the obtained filtration membrane is subjected to a baking treatment under predetermined baking conditions. The baking temperature may range from 100° C. to 300° C. The baking time of the baking conditions may be appropriately selected to allow sufficient curing of the modification layer, and may be, for example, between 1 hour and 6 hours.

Further details will be described in the present disclosure by referencing to following Examples which are in no way intended to limit the scope of the present disclosure.

### Example

### (1) Evaluation Method

### (1-1) Microscopic Observation

### 1. Scanning Electron Microscopy (SEM)

The images of surface and cross-sectional morphology of the filtration membrane were captured using a scanning electron microscope to confirm its structural features. Additionally, element distribution of the filtration membrane was examined using scanning electron microscopy-energy dispersive X-ray spectroscopy (SEM-EDS). The scanning electron microscope used in this embodiment of the present disclosure was a JEOL JSM-6500F.

2. Images of the emulsion before and after filtration through the filtration membrane were captured using an optical microscope to evaluate the filtration status of the emulsion. The optical microscope used was the SOPTOP RX50M, which was used to observe the emulsion, the filtrate, and the filter cake.

### (1-2) Measurement of Water Contact Angle

A surface tension analyzer (First Ten Angstrom, model FTA 125) was used for contact angle measurements. The filtration membrane sample was fixed onto a glass slide, and a 3 μL droplet of either water or decane was dropped onto the surface of the sample of the filtration membrane. The contact angle relative to water or oil was recorded after 5 seconds. Each sample was measured five times at different positions, and the average value was calculated.

### (1-3) Measurement of Oil-Water Separation Efficiency

A Karl Fischer titrator (SI Analytics, model 7500KF trace) was used in this example. Prior to measurement, system stability was verified using a standard sample with a water content of 0.1%, and the experiment was conducted in accordance with the manufacturer's operating manual. The water content in the filtrate after filtration through each filtration membrane sample was measured, and the oil-water separation efficiency was calculated the using following formula:

$$Oil - water separation efficiency ( \% ) = ( Water content of emulsion sample - Water content of filtrate ) / Water content of emulsion sample \times 100$$

### (1-4) Definition of Surface Energy

The surface energy of each modifying agent was referenced from data obtained via the SciFinder online database.

### (2) Preparation of Filtration Membrane

### (2-1) Confirmation of Etching Conditions

A stainless steel mesh with a 2800 mesh size (about 4 to 5 μm pore size) was used as the main substrate. After washing with acetone and drying, the stainless steel mesh was immersed in an etching solution for static etching for 30 seconds, 1 minute, or 3 minutes, followed by washing with water. The etching solution was a mixture prepared by 1 M FeCl₃, 12 M hydrochloric acid (HCl), and 5% hydrogen peroxide (H₂O₂) at a volume ratio of 20:1:1.

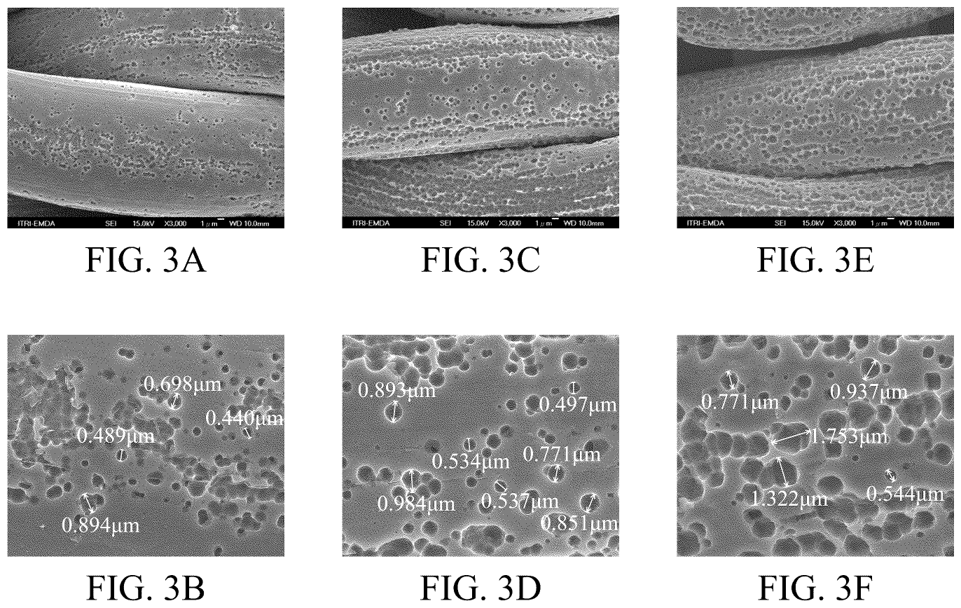

Subsequently, polydimethylsiloxane (PDMS) was used as the modifying agent to evaluate the relationship between etching time and water contact angle, as shown in FIGS. 3A-3F. FIG. 3A and FIG. 3B respectively correspond to etching for 30 seconds; FIG. 3C and FIG. 3D respectively correspond to etching for 1 minute; and FIG. 3E and FIG. 3F respectively correspond to etching for 3 minutes. The results showed that the microstructures were not sufficiently developed at 30 seconds. Based on water contact angle measurements, the sample etched for 30 seconds exhibited a water contact angle of 125 degree, whereas etching for 1 minute and 3 minutes resulted in increased water contact angles of 130° and 137°, respectively. Accordingly, an etching time of 3 minutes was adopted for the preparation of the filtration membrane in the subsequent examples.

### (2-2) Confirmation of Modification Process

### Process A: Dip Coating Method

Octadecyltrichlorosilane (ODTCS) was used as the modifying agent and dissolved in tetrahydrofuran (THF) to prepare a 60 mM modification solution. The etched stainless steel mesh was immersed in the modification solution comprising the modifying agent for 3 minutes. After removal, the sample was allowed to stand until the modification solution had completely evaporated, followed by baking at 60° C. for 4 hours.

### Process B: Non-solvent Induced Phase Separation Method

Octadecyltrichlorosilane (ODTCS) was used as the modifying agent and dissolved in THF to prepare a 60 mM modification solution. Moreover, an aqueous solution containing 20% ethanol was prepared. The etched stainless steel mesh was immersed in the modification solution comprising the modifying agent for 3 minutes, then immediately immersed in the 20% ethanol aqueous solution for 30 seconds, removed and baked at 60° C. for 4 hours.

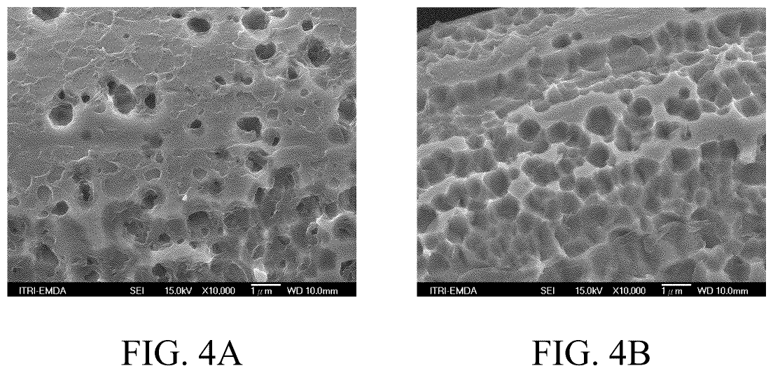

As shown in FIGS. 4A and 4B, FIG. 4A corresponds to the filtration membrane prepared by Process A (dip coating method), while FIG. 4B corresponds to the filtration membrane prepared by Process B (non-solvent induced phase separation method). The images clearly show that, under Process A, the recessed microstructures on the surface of the modification layer are not apparent and the pore sizes are smaller (average pore size about 0.3 to 0.5 μm), with more recessed microstructures covered by the modification layer. As a result, the surface of the modification layer with filamentous structures occupies a larger proportion of the image, indicating that the modification layer has partially filled or flattened the recessed microstructures of the stainless steel mesh. In contrast, under Process B, the surface of microstructures shows distinct recessed surface with an average pore size of approximately 0.8 to 1.2 μm, indicating the modification layer is coated on the mesh structure in a manner that conforms to the morphology of the microstructure, such that the modification layer adheres along a surface relief without filling or flattening the microstructure.

### (2-3) Confirmation of Modifying Agent Concentration

Octadecyltrichlorosilane (ODTCS) as the modifying agent was dissolved in tetrahydrofuran (THF) to prepare modification solutions with concentrations of 10 mM and 60 mM, respectively. These solutions were applied using the Process B described above to prepare filtration membranes with different modifying agent concentrations.

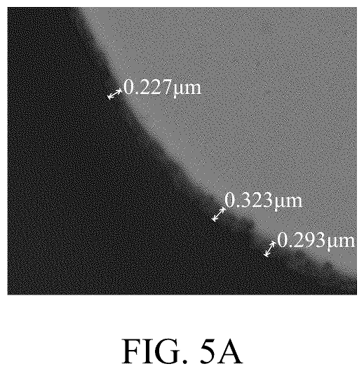

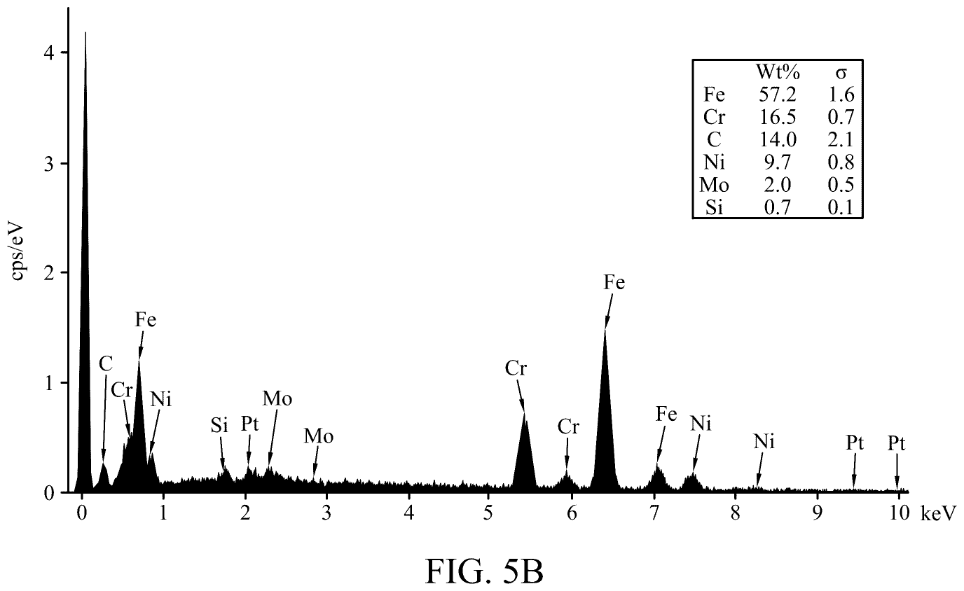

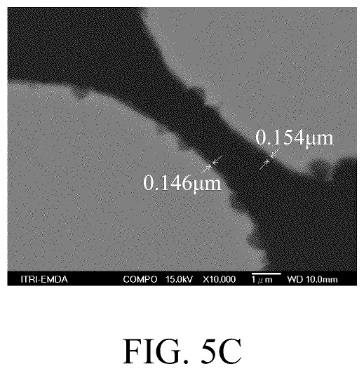

As shown in FIGS. 5A, 5B, and 5C, FIG. 5A presents the SEM image of the filtration membrane prepared with a 60 mM modifying agent concentration; FIG. 5B shows the SEM-EDS elemental analysis of the filtration membrane prepared with a 60 mM; and FIG. 5C shows the SEM image of the filtration membrane prepared with a 10 mM modifying agent concentration. FIG. 5A indicates that a modification layer with a thickness of over approximately 200 nm was formed using the 60 mM modifying agent. While FIG. 5C shows that even with a 10 mM modifying agent, a modification layer with a thickness of over approximately 140 nm can be obtained, indicating that a sufficient layer thickness can be obtained even with a lower concentration of the modifying agent. In addition, FIG. 5B demonstrates that no chlorines from in the modifying agent was detected in the elemental analysis, confirming that the chlorines in ODTCS were removed during the process due to dehydration reactions.

### (3) Preparation of Examples

In addition to varying the types of modifying agents, various examples were prepared based on the above-described processes. The types of modifying agents used (or not used) in each example are shown in Table 1 below. Furthermore, in Examples 1 to 6, etched stainless steel meshes were used, and the concentration of the modifying agent concentration for Examples 1 to 6 was 0.3 wt %.

TABLE 1

| | |
|---|---|
| Comparative Example 1 | stainless steel mesh |
| Comparative Example 2 | Etched stainless steel mesh |
| Example 1 | Octadecyltrichlorosilane, ODTCS |
| Example 2 | Octadecyltrimethoxysilane, ODTMS |
| Example 3 | Methyltrichlorosilane, MTCS |
| Example 4 | silicon oil |
| Example 5 | Polystyrene, PS |
| Example 6 | Polydimethylsiloxane, PDMS |

### (4) Evaluation of Filtration Membrane Performance

### (4-1) Contact Angle Measurement for Water and Oil

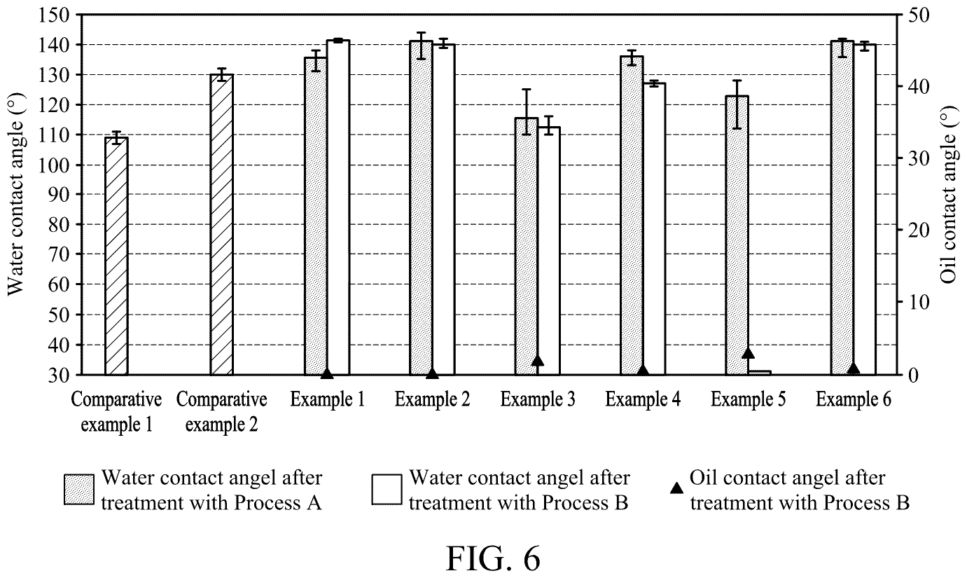

FIG. 6 shows the water and oil contact angle results for Examples 1 to 6, which were etched and then treated by either Process A or Process B, and modified with different surface modifying agents. In Examples 1, 2, and 6, the etched stainless steel meshes treated with either Process A or Process B exhibited significantly increased water contact angles and lower oil contact angles, indicating enhanced hydrophobicity and improved oleophilic properties. Moreover, after treatment with Process B, the variation in water contact angle measurements was relatively small, indicating that Process B contributes to improved coating uniformity. The results of Example 3 demonstrate that the water contact angle did not show significant change; however, after treatment with Process B, the variation in water contact angle was reduced, indicating more stable filtration membrane performance produced by process B. The results of Example 4 demonstrate that modification treatment resulted in a significant increase in hydrophobicity, along with good oleophilic properties, Process B treatment also resulted in reduced variability in water contact angle measurements. In Example 5, although polystyrene is known as a hydrophobic polymer, the resulting filtration membrane exhibited poor hydrophobic performance and relatively high lipophilicity, indicating that the process may not be suitable for certain types of organic polymer compounds.

### (4-2) Filtration Membrane Morphology

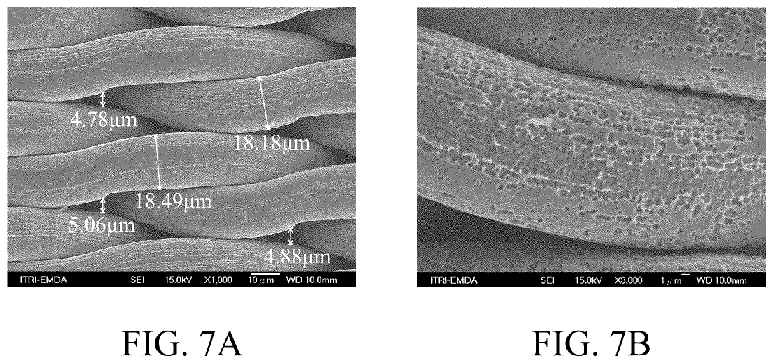

The morphology of the filtration membrane in Example 3 was observed using scanning electron microscopy, and the results are shown in FIGS. 7A and 7B. FIG. 7A confirms that the formation of the modification layer does not affect the pore size of the mesh structure, which remains approximately 4 to 5 μm, thereby ensuring that the filtration performance of the filtration membrane is not compromised. Furthermore, FIG. 7B clearly shows that even if the modification layer is coated on the mesh structure in a manner that conforms to the morphology of the microstructure, such that the modification layer adheres along a surface relief without filling or flattening the microstructure, allowing the recessed microstructures to remain distinctly visible on the surface of the filtration membrane.

### (4-3) Results of Oil-Water Separation Efficiency

A standard Pickering emulsion was prepared. Specifically, a mixture of microparticles consisting of silicon carbide powder and diamond powder (about 3 wt %) was mixed in water, followed by the addition of an appropriate amount of decane as the oil-phase solvent. The mixture was then agitated to achieve emulsification, thereby forming a Pickering emulsion containing microparticles. Filtration membranes from each of the examples and comparative examples were installed in a funnel connected to a flask. The prepared emulsion was poured into the funnel for filtration, yielding both a filter cake and a filtrate. The water content of each filtrate was measured using the method described above, and the oil-water separation efficiency was calculated based on the formula describe above. The results are summarized in Table 2 below.

TABLE 2

| | Comparative | Example | Example | Example | Example | Example | Example |
|---|---|---|---|---|---|---|---|
| | example 1 | 1 | 2 | 3 | 4 | 5 | 6 |
| Surface | — | 29 | 28 | 20 | 21 | 34 | 24 |
| Energy | | | | | | | |
| (mN/m) | | | | | | | |
| Oil-Water | 61 | 99.9 | 99.9 | 91.2 | 97.1 | 71.5 | 98.7 |
| Separation | | | | | | | |
| Efficiency | | | | | | | |
| (%) | | | | | | | |

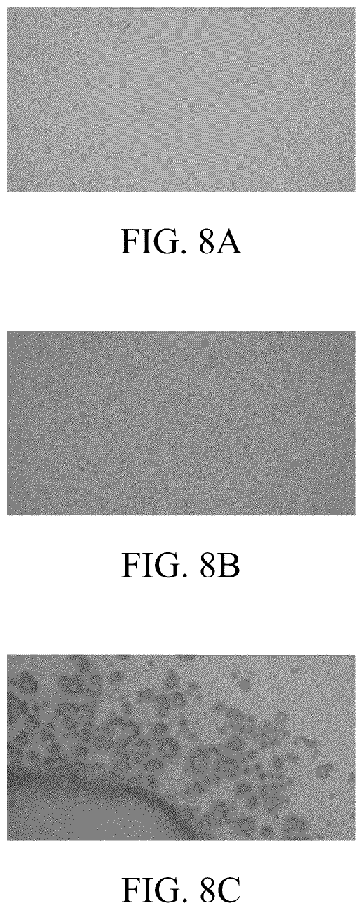

As shown in FIGS. 8A-8C, the images (200× magnification) were captured using an optical microscope. FIG. 8A shows the emulsion before filtration; FIG. 8B shows the filtrate after filtration in accordance with Example 1; and FIG. 8C shows the filter cake after filtration in accordance with Example 1. Based on these images of FIGS. 8A-8C, the filtrate appears as a clear solution, in contrast to the emulsion before filtration, which contains microparticles or microdroplets. The image of the filter cake shows clearly aggregated particle clusters, with dispersed particles surrounding the clusters, indicating that the filtration membrane of the present disclosure has an excellent microparticle filtration performance. Furthermore, as shown in Table 2, Examples 1, 2, and 6 exhibit extremely high oil-water separation efficiency, demonstrating excellent hydrophobic and oleophilic performance.

The filtration membrane of the present disclosure exhibits excellent durability due to the use of a stainless steel mesh. In contrast to organic polymer-based substrates, its surface more easily allows the formation of microstructures. This structure enables demulsification at room temperature and effectively enhances the hydrophobic and oleophilic performance. In addition, the stainless steel mesh of the present disclosure has a small pore size, enabling effective microparticle filtration. As a result, the filtration membrane disclosed herein is well-suited for practical implementation in filtration devices for applications such as wastewater treatment, demonstrating excellent applicability.

What is claimed is:

1. A filtration membrane, comprising:
a mesh structure, wherein the mesh structure comprises stainless steel, has a pore size of 10 μm or less, and comprises a microstructure on a surface of the mesh structure; and
a modification layer comprising an alkoxysilane compound, a halosilane compound, or a polyalkylsiloxane compound, disposed on the mesh structure, wherein the modification layer is coated on the mesh structure in a manner that conforms to the morphology of the microstructure.

2. The filtration membrane as claimed in claim 1, wherein the alkoxysilane compound is a methoxysilane compound.

3. The filtration membrane as claimed in claim 1, wherein the halosilane compound is a chlorosilane compound.

4. The filtration membrane as claimed in claim 1, wherein the polyalkylsiloxane compound is a polydimethylsiloxane compound.

5. The filtration membrane as claimed in claim 1, wherein the alkoxysilane compound or the halosilane compound comprises an alkyl functional group having 8 to 18 carbon atoms.

6. The filtration membrane as claimed in claim 1, wherein the microstructure comprises a plurality of depressions, each of the depressions having a diameter ranging from 0.2 μm to 3 μm and a depth ranging from 10 nm to 300 nm.

7. The filtration membrane as claimed in claim 1, wherein the modification layer has a thickness ranging from 100 nm to 400 nm.

8. A filtration device, comprising a filtration membrane, wherein the filtration membrane comprises:
a mesh structure, wherein the mesh structure comprises stainless steel, has a pore size of 10 μm or less, and comprises a microstructure on a surface of the mesh structure; and
a modification layer comprising an alkoxysilane compound, a halosilane compound, or a polyalkylsiloxane compound, disposed on the mesh structure, wherein the modification layer is coated on the mesh structure in a manner that conforms to the morphology of the microstructure.

9. A method for manufacturing a filtration membrane, comprising:
(a) etching a mesh structure comprising a stainless steel to form a microstructure on a surface of the mesh structure, wherein the mesh structure has a pore size of 10 μm or less;
(b) dissolving a modifying agent comprising an alkoxysilane compound, a halosilane compound, or a polyalkylsiloxane compound in a first solvent to obtain a modification solution; and
(c) coating the modification solution on the mesh structure that has been etched, to form a modification layer, wherein the modification layer is coated on the mesh structure in a manner that conforms to the morphology of the microstructure.

10. The method as claimed in claim 9, wherein the alkoxysilane compound is a methoxysilane compound.

11. The method as claimed in claim 9, wherein the halosilane compound is a chlorosilane compound.

12. The method as claimed in claim 9, wherein the polyalkylsiloxane compound is a polydimethylsiloxane compound.

13. The method as claimed in claim 9, wherein the alkoxysilane compound or the halosilane compound comprises an alkyl functional group with 8 to 18 carbons.

14. The method as claimed in claim 9, wherein the first solvent is an organic solvent that is capable of dissolving the silane compound and is miscible with water.

15. The method as claimed in claim 9, further comprising: (d) performing a baking process on the filtration membrane obtained in step (c) under a baking condition.

16. The method as claimed in claim 15, wherein the baking condition comprises a baking temperature ranging from 60° C. to 200° C. and a baking time ranging from 2 hours to 24 hours.

17. The method as claimed in claim 9, wherein step (c) further comprises:
preparing a second solvent and immersing the mesh structure with the modification layer formed thereon into the second solvent, wherein the second solvent is different from the first solvent.
